(19) United States
(12) Patent Application Publication
(10) Pub. No.: US 2013/0320683 A1
(43) Pub. Date: Dec. 5, 2013

(54) GRAVITY POWERED GENERATOR (ARTILLERY 9)

(71) Applicant: JEEVAN SUNAR, Granbury, TX (US)

(72) Inventor: JEEVAN SUNAR, Granbury, TX (US)

(21) Appl. No.: 13/484,280

(22) Filed: May 31, 2012

(51) Int. Cl. H02K 7/18; F03G 7/00

(52) U.S. Cl. 290/1 R; 60/398

(57) ABSTRACT

This is a power generating technology that uses gravity as its fuel supplies. This technology harnesses the power of gravity without any dependable sources like hydro, wind, petroleum products etc. and generates power supply. The technology is based on a simple theory which basically states the output energy is possible, if certain mass rotates under gravity and when small amount of the energy generated by the movement of that mass is applied towards the direction of same moving or falling mass. The technology is possible because the mass is used as an independent source of fuel, which is caused, by the combined act of gravity and transformation of energy through assist circuit. My prototype has become the self-evidence that it can be used as a power generator or a motor for industries and harvest energy without any dependable sources.

### FIELD OF INVENTION

The presented invention is all about the technology of a machine that generates power (energy) without any conventional fuel, hydro, electricity, wind, or solar. It is totally dependent on gravity to generate the power (energy).

The technology is viable, reliable and with an independent reliable inbuilt source (mass), has the ability to solve the energy crisis of the world. There arise a great possibility for humanitarian objective plus a great relief in the commercial market. It genuinely opens the doors for many intellectual people and march the world toward green and clean world. Energy is the power for human progress and this is a perfect technology. Both the theory and technology serve the human kind for long run.

### BACKGROUND OF INVENTION

Any technology has a background and has to inspire by other technology to get into a practical life. This too has connection with many technologies and theories. This technology is inspired by the theoretical physics of a kid's toy (top), yet it has its own principal to run independent and has individual property to be unique. There are two main backgrounds for this technology, a pendulum and a flywheel; both are unique to each other. The pendulum doesn't have a real contribution in generating energy and the flywheel has various applications but it too doesn't generate energy, it can just store some energy for a while. To come up with this technology both of those technologies had to be research thoroughly and combine if possible. I did more than that, I broke through a new cutting edge technology that only runs with gravity and independent fuel source of its own i.e. mass and now it barely has those two impressions.

I formulated this theory nine years ago but the scientific intellectuals of Nepal did not recognize it because they thought it was hypothetical. The technology has been underground due to lack of vision of economist and corrupted government of Nepal. Realizing the fact that I could not get any help from concerned department of government or private sector in Nepal, I started this project with my friends and schoolmates to make a prototype. It just took us six months to prove this theory into technology and prove this hypothesis into practical machine. The nine-year were treacherous and hard but succeeded finally.

### BRIEF SUMMARY OF THE INVENTION

The technology is basically all about a push to a falling mass under gravity and making one same initial and final point of energy. The mass and distance are the key players and gravity alone does 99% of work i.e. generates energy as the mass fall under gravity. I will be explaining all about this technology on the basis of the figure below and my prototype. The figure might be a bit different from any other physics book of conservation of energy because of lack of my knowledge on high-level science (physics) terms.

### BRIEF DESCRIPTION OF THE DRAWINGS

FIG. 1 is an illustration of a mass dropping freely towards ground and its bounce back in a normal condition.

FIG. 2 is an illustration of same mass dropping freely towards ground but with a push force at initial point.

FIG. 3 describes the same principle as FIG. 1 but in a rotary motion. It illustrates a mass attached to a fixed point by a shaft which can freely rotate around the fixed point is dropped down from 89 degree and that only reaches to 91 degree.

FIG. 4 illustrates the process of same mass rotating infinitely around fixed point with push force at point A.

FIG. 5 is a diagram of upper view of the prototype.

FIG. 6 is a diagram of front view of the prototype.

FIG. 7 is a diagram of my assist circuit that gives the push force to the mass and transmits the energy outcome.

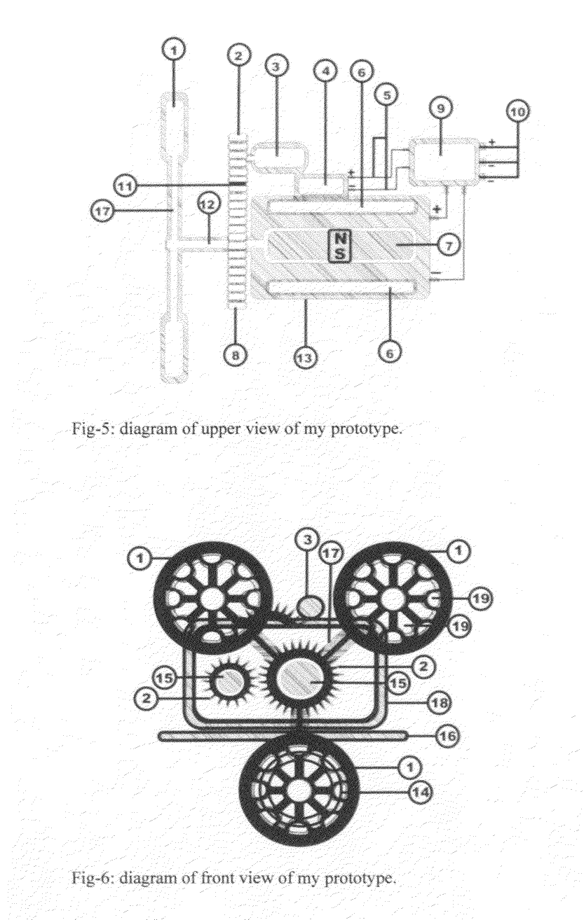

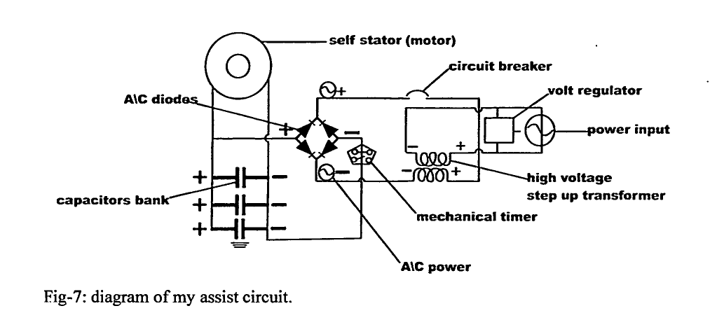

### NUMBERING IN FIG. 5 AND FIG. 6

1. G blades
2. Small gears
3. Starter
4. Assist circuit
5. Input wire connection
6. Copper wire (300 turns)
7. 52 poles permanent magnet
8. Large gears
9. Electric transmitter
10. Output wire connection
11. Gears connection
12. Mechanical energy transmitting shaft
13. Custom generator/dynamo
14. Heavy mass
15. Gear shaft
16. Machine base
17. Leverage (distance efficiency)
18. Parts organizer/parts holder
19. Air resistance G blade design

### DETAILED DESCRIPTION OF THE INVENTION

First figure shows the technology in a linear position but the linear position explains this technology virtually or theoretically only. These figures theoretically explain how our prototype is functioning and how everything that theory suggests is applied practically for free energy output.

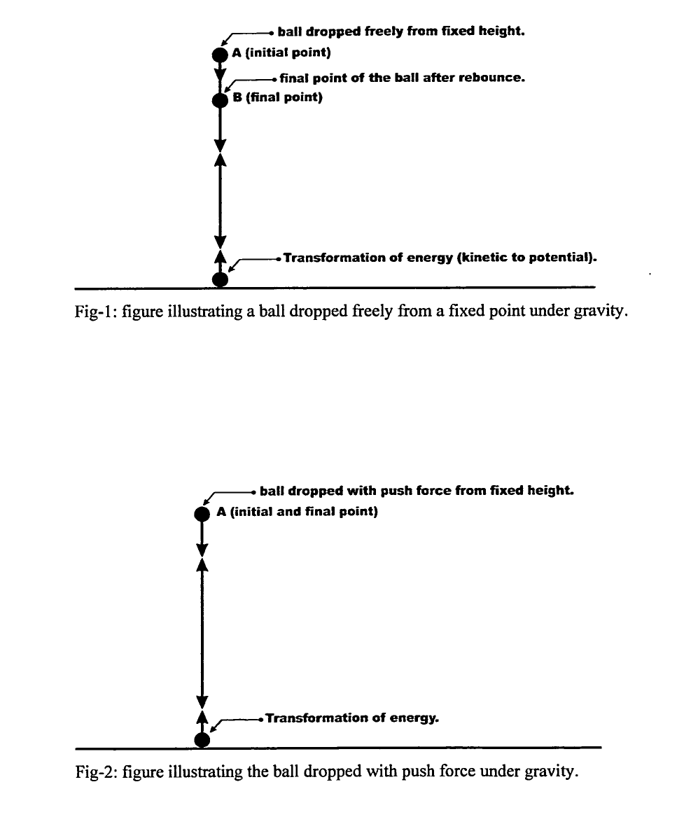

FIG. 1 explains about the first attempt where a ball is dropped freely towards the ground from a fixed height, point A. The ball touches the ground and bounce back towards the initial point from where it was dropped but it only reaches to point B, which is lower than point A. FIG. 2 explains about the second attempt where the same ball is dropped from the same height, point A. But this time a slight push force was applied to the ball towards the ground at point A. The ball touches the ground and bounce back towards the initial point and this time the ball reaches to the same height from where it was dropped, i.e. point A.

These two attempts clearly explains that if a certain amount of force is applied to a falling mass the falling mass can return to its original point. This is the universal fact that we all know so this is not my claim. My claims starts now where I used same principle to the rotary motion and discover the key to use the same energy gained by the mass as a slight push force at 89 or 91 degree.

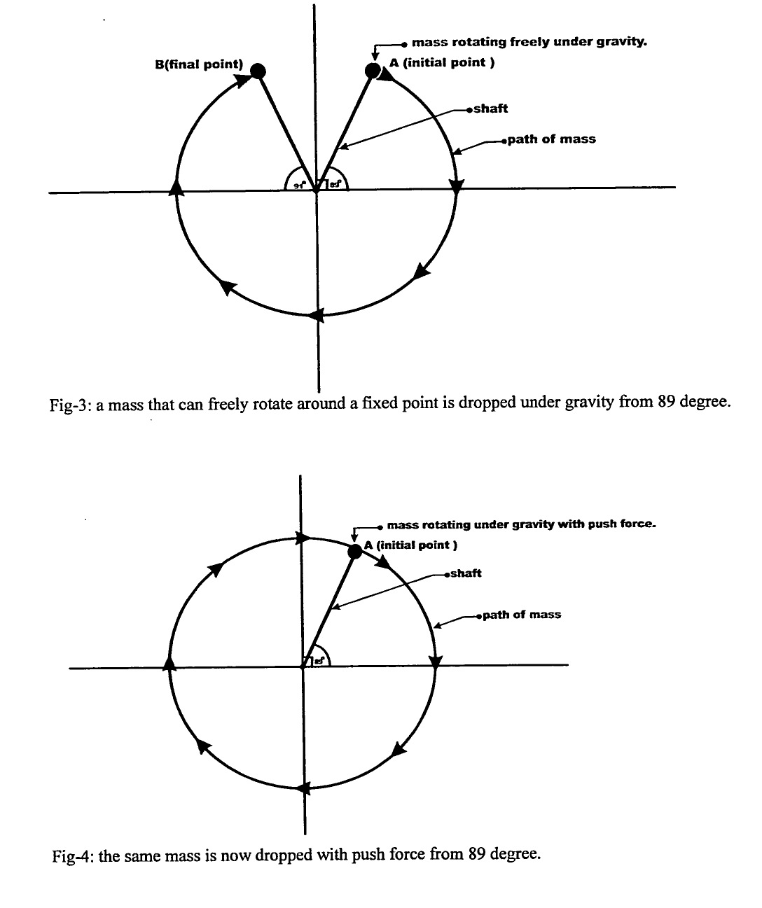

FIGS. 3 and 4 are same as FIGS. 1 and 2 respectively but in a rotary motion. FIG. 3 is an attempt where a fixed mass is attached to a shaft that can freely rotate 360 degree under gravity around a fixed point like a wind turbine. In this attempt the mass is dropped freely under gravity from point A, i.e. 89 degree. The mass rotates in fixed path and reaches only up to point B, i.e. 91 degree. Thus, there is no possible energy output in this attempt.

FIG. 4 is an attempt where I applied my theory to the same revolving mass. At point A, i.e. 89 degree, a small amount of an initial external force was applied to the mass as a push force. The mass rotates under the gravity in same fixed path and reaches the initial point, point A, i.e. 89 degree. Now at this point the transformation of energy takes place. 1% of energy gained by the mass is transformed into the push force for the mass through assist circuit. As the mass gets its push force it again rotates through same fixed path under the gravity and reaches the initial point, point A, i.e. 89 degree. This process is repeated again and again and the mass rotates in same fixed path infinitely. 1% of energy gained by the mass is used in transformation and the remaining 99% of energy is our outcome. 2% of energy is wasted due to the heat loss, generator fluctuation, wire resistance, negligence friction on gear and generator, anti torque etc. thus, 97% of energy is our net energy outcome.

The Technology Has three G blades. Only one has the heavier mass that does the whole job and the other are just for the assistance. The blades are designed in such a way that they can rotate for almost five minutes with just a touch of 0.5 Newton external force i.e. working like a flywheel battery. The prototype machine runs through following steps:
Firstly the heavier mass (number 14 in FIG. 6) is position at 89 degree for clockwise rotation or 91 degree for anticlockwise rotation.
This positioning of mass at point 89/91-degree triggers (turn on) the automated self-starter with combine assist circuit (number 4 in FIG. 5).
Then the starter (number 3 in FIGS. 5 and 6) kicks the heavier mass (number 14 in FIG. 6) adding energy to G blades (number 1 in FIGS. 5 and 6). Assist circuit (number 4 in FIG. 5) stops when the mass passes 89 degree.
This leads to boost energy and heavier mass (number 14 in FIG. 6) to complete 360 with the ease assistance from other two blades and assist circuit (number 4 in FIG. 5).
This action rotates the dynamo's shaft. With the transformation of energy through gears (number 2 in FIGS. 5 and 6) generate energy like a butter cutting through a knife without any drag or any anti torque.
Every time the heavier mass (number 14 in FIG. 6) reaches 89 degree the assist circuit adds up the energy as push force to it due to which it reaches to 89 degree again. Thus, the mass rotates infinitely.
This is possible when a mass packed over 196 Newton force accelerates toward the initial/final point (89 degree in this prototype) with the help of specially designed G blades plus the energy added by assist circuit (self stator).
The action generates energy and power is transmitted to transmitter (number 9 in FIG. 5). The assist circuit as input takes 1% of energy and 99% of energy is passed through output wire connection (number 10 in FIG. 5) as output.

Thus, the output is distributed; 1% for the assist circuit to charge the capacitors and 97% genuinely for our external use that comes out through output wire connection (number 10 in FIG. 5). 2% is lost due to heat loss, generator fluctuation, wire resistance, negligence friction, anti torque etc.

### Prototype Details

Power input: 1% (exact value: 12 volt 5 amperage DC) only once at starting the machine.

Power output: 1000 watt (approx.)
Power output with modified generator: 900 watt
Power output with transformer or AVR kit: 2000 watt

No conventional fuel

No dependent source as hydro, wind or solar etc.

Use only gravity as fuel with inbuilt independent source that is mass and height of fall.

Height: 2.5 m (8′2.4″)

Length: 1 m (3′3.37″)

Breadth: 0.5 m (1′7.69″)

Weight: 79 kg (175 lbs.)

Number of G blades: 3, with different individual mass that are adjustable according to the need. G blade is design in a unique way so it runs freely without any practical effect of friction.

I claim:

1. Any mass falling freely under the gravity with negligent friction and negative forces can be used as fuel source.

2. (canceled)

3. (canceled)

4. (canceled)

5. The core principle for the Automation of this kind of machine lies on two basic things, transformation of energy and point 89 degree for clockwise rotation or 91 degree for anti-clockwise rotation as initial and final point. One of those points is the best point to transform energy i.e. give the push force to mass. It only consumes the fraction of energy during transformation through just a spark or boost and the energy wasted in a fraction of second doesn't have any effect on the performances.

6. (canceled)

7. (canceled)

8. (canceled)

9. (canceled)

10. (canceled)

11. (canceled)

12. The main idea is to make only one same initial and final point, which is not possible in a linear path. So, in a circular path the 89 or 91 degree can be used as initial and final point. The mass acts as fuel and its movement is the energy. Thus, transformation of energy at that one initial and final point makes the output possible.

13. (canceled)

14. (canceled)

15. (canceled)

16. (canceled)

17. (canceled)

18. (canceled)

19. (canceled)

20. This technology is fully automated to transform energy for internal and external use that means the transformation of the force of gravity to mechanical energy to electrical energy by simple principle that I have stated on above claims.
